(19) United States
(12) Patent Application Publication
(10) Pub. No.: US 2015/0286215 A1
(43) Pub. Date: Oct. 8, 2015

(54) METHODS AND APPARATUS TO PREDICT LANDING SYSTEM OPERATING PARAMETERS

(71) Applicant: The Boeing Company, Chicago, IL (US)

(72) Inventors: Santiago Alvarado, JR., Seattle, WA (US); Joseph M. Wapenski, Snohomish, WA (US)

(21) Appl. No.: 14/309,252

(22) Filed: Jun. 19, 2014

Related U.S. Application Data
(63) Continuation-in-part of application No. 14/245,504, filed on Apr. 4, 2014, now abandoned.

(51) Int. Cl. G05D 1/00; G05D 1/02; B64D 45/00

(52) U.S. Cl. CPC G05D 1/0083; B64D 45/00; G05D 1/0202

(57) ABSTRACT

Methods and apparatus to predict landing system operating parameters are described herein. One described example method includes measuring a value of an operating parameter of a landing system of an aircraft, and determining a ground travel path. The example method also includes determining a predicted value of the operating parameter corresponding to the ground travel path where the predicted value is based on the value of the operating parameter and the ground travel path.

### RELATED APPLICATION

This patent is a continuation in part of U.S. patent application Ser. No. 14/245,504, which was filed on Apr. 4, 2014 and is hereby incorporated herein by reference in its entirety.

### FIELD OF THE DISCLOSURE

This patent relates generally to aircraft landing systems and, more particularly, to methods and apparatus to predict landing system operating parameters.

### BACKGROUND

Typical aircraft include wheels and brakes to facilitate taxiing, landing, parking, etc. The brakes of such aircraft generate heat while decelerating the aircraft, for example. Generally, excessive brake heat can cause component damage and/or wear and may also require the aircraft to be temporarily stopped to allow the brakes to cool to ensure equipment is operated within its certified operating envelope. A Brake Temperature Monitoring System (“BTMS”) may be used to monitor an operating parameter such as temperatures of brakes in an aircraft, for example. In some examples, the BTMS value represents these temperatures as unitless numbers or ratios to convey the amount of heat present in the brakes of the aircraft. Often, during an approach for landing of an aircraft, choosing certain exit points of a runway may impact brake temperatures differently. Excessive brake heat or brake heat above a certain threshold level can necessitate a wait time (e.g., dispatch time) for an aircraft to allow the brakes to cool.

### SUMMARY

One described example method includes measuring a value of an operating parameter of a landing system of an aircraft, and determining a ground travel path. The example method also includes determining a predicted value of the operating parameter corresponding to the ground travel path where the predicted value is based on the value of the operating parameter and the ground travel path.

One described example apparatus includes a sensor mounted to a landing system of an aircraft to measure an operating parameter of the landing system, and a calculator to determine a predicted value of the operating parameter based on the operating parameter and one or more of a measured external condition, or a potential ground travel path.

Another described example method includes measuring an operating parameter of a landing system of an aircraft and measuring a conditional parameter of the landing system. The example method also includes comparing, using a processor, one or more of the operating parameter or the conditional parameter to empirical data to predict a dispatch turn time or brake temperature value of the aircraft.

### BRIEF DESCRIPTION OF THE DRAWINGS

FIG. 1 illustrates an example aircraft that may be used to implement example methods and apparatus disclosed herein.

FIG. 2 illustrates an example aircraft landing system including rolling stock of the aircraft of FIG. 1.

FIG. 3 illustrates an example wheel assembly of the aircraft landing system of FIG. 2.

FIG. 4 is a graph depicting a time-temperature history of brake temperature after an aircraft braking event.

FIG. 5 illustrates an example instrument panel readout of an aircraft displaying brake temperature values.

FIG. 6 is an example brake system apparatus in accordance with the teachings of this disclosure.

FIG. 7 is a schematic representation of a brake system of an aircraft that may be used to implement the brake system apparatus of FIG. 6.

FIG. 8 is a flowchart representative of an example method that may be used to implement the brake system apparatus of FIG. 6.

FIG. 9 is another flowchart representative of another example method that may be used to implement the brake system apparatus of FIG. 6.

FIG. 10 is a block diagram of an example processor platform capable of executing machine readable instructions to implement the methods of FIGS. 8 and 9.

FIG. 11 illustrates an example display for use with the examples described herein.

FIG. 12 illustrates another example display for use with the examples described herein.

FIG. 13 illustrates another example display for use with the examples described herein.

Wherever possible, the same reference numbers will be used throughout the drawing(s) and accompanying written description to refer to the same or like parts. As used in this disclosure, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus to monitor components of an aircraft landing system are disclosed herein. During a braking event of an aircraft such as, for example, landing, taxiing, parking, etc., heat is generated by components (e.g., rotors and stators) of a brake assembly. Such heat is transferred from the brake assembly to a wheel operatively coupled to the brake assembly. The wheel may include a fuse plug, which includes a seal that melts at or above a threshold temperature. If the seal melts, air is released from a tire on the wheel. After one braking event or a plurality of braking events in a given period of time, a temperature of the fuse plug may increase toward the threshold temperature. Heat from the brake assembly may be transferred to the fuse plug during the braking event (e.g., as the brakes are applied during landing) and after the braking event (e.g., during taxiing, once the aircraft is parked, etc.). Thus, a temperature of the fuse plug may continue to increase following the braking event. Often, before landing, multiple available ground pathways (e.g., exit points, ground travel paths) may be chosen. Typically, each ground travel pathway exit point has a different corresponding thermal effect on the brake assembly (e.g., some ground paths may require a waiting period to allow brakes and/or the tires to cool below a threshold). Additionally, different ground travel path exit points may necessitate different dispatch turn times (e.g., mandatory waiting times resulting from a brake overheat condition) based on potential overheating of the brakes.

The examples disclosed herein may be used to predict operating parameters (e.g., brake temperatures and/or dispatch turn time) corresponding to respective ground travel pathways, thereby enabling an operator of the aircraft, an aircraft control system, etc. to determine an exit point ground travel pathway, for example, to prevent a fuse plug from melting and/or prevent the need for an aircraft waiting time due to an overheat condition of the brakes. As used herein, the terms determine or determination refer to a computing. calculating and/or predicting a result based on various input(s). Hence, the term determine may be used interchangeably with the term compute and/or calculate, and the term determination may be used interchangeably with the computation. The examples disclosed herein may allow conditional parameter values (e.g., gross weight, runway elevation, ambient (e.g., outside) air temperature, etc.) and/or deceleration settings (e.g., internal conditions such as thrust reverser settings, autobrake deceleration level, etc.) to be used in conjunction with brake cooling schedule data to determine a computed operating parameter value (e.g., brake temperature monitoring system or “BTMS” value, brake temperature value, etc.). The computed operating parameter value may be combined with a measured operating parameter value (e.g., measurement, reading, etc.) to determine a predicted operating parameter value corresponding to each aircraft exit point. Such predicted operating parameter values allow aircraft personnel to more effectively select aircraft exit points, for example, by being informed of potential brake system performance. For example, the aircraft personnel may select an exit point based on time savings, but such time savings may be negated or reduced by a potential required aircraft wait time to cool the brakes and/or the tires of the aircraft.

In some examples, an message may be displayed or generated if a predicted operating parameter value exceeds a threshold and/or if a predicted dispatch turn time exceeds a threshold. In some examples, the operating parameter value is predicted in conjunction with an automated braking system (e.g., autobrake) to set a minimum threshold for applied braking pressure for landing an aircraft.

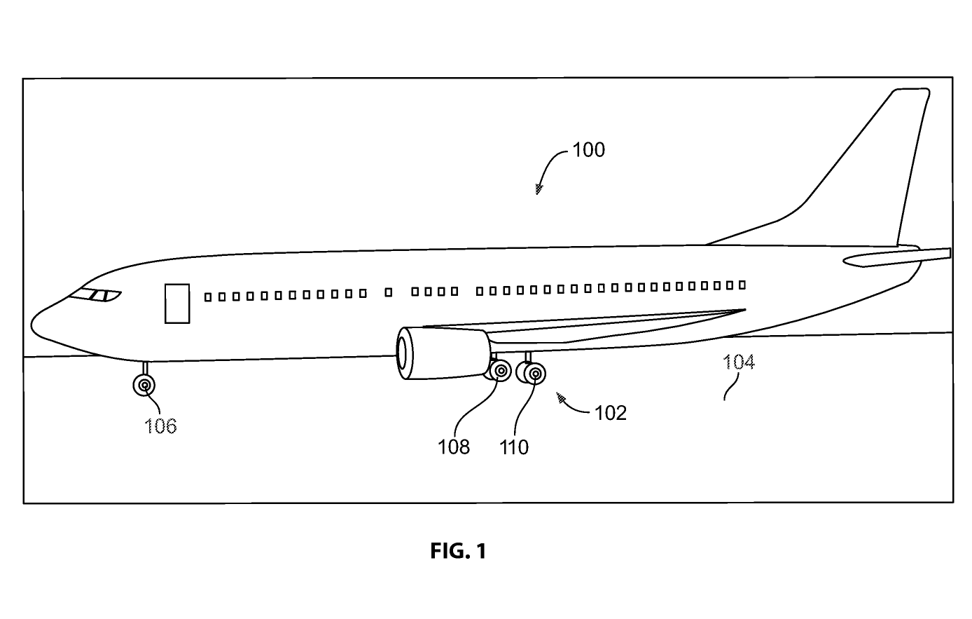

FIG. 1 illustrates an example aircraft 100, which may be used to implement the examples disclosed herein. In the illustrated example, the aircraft 100 includes a landing system 102 to support the aircraft 100 on a surface 104 (e.g., a runway) and enable the aircraft 100 to taxi, take off, land, etc. The example landing system 102 includes a front landing gear unit 106 and two rear landing gear units 108 and 110. However, the above-noted numbers of front and rear landing gear units are merely examples and, thus, other examples may employ other numbers of front landing gear units and/or rear landing gear units without departing from the scope of this disclosure.

To travel from one destination (e.g., an airport) to another, the example aircraft 100 may perform a plurality of braking events such as, for example, taxiing from a departure gate to a runway, landing, taxiing from a runway to an arrival gate, and parking. During a given time period (e.g., one day), the example aircraft 100 may travel or be scheduled to travel to a plurality of destinations and, thus, perform or be scheduled to perform a plurality of braking events.

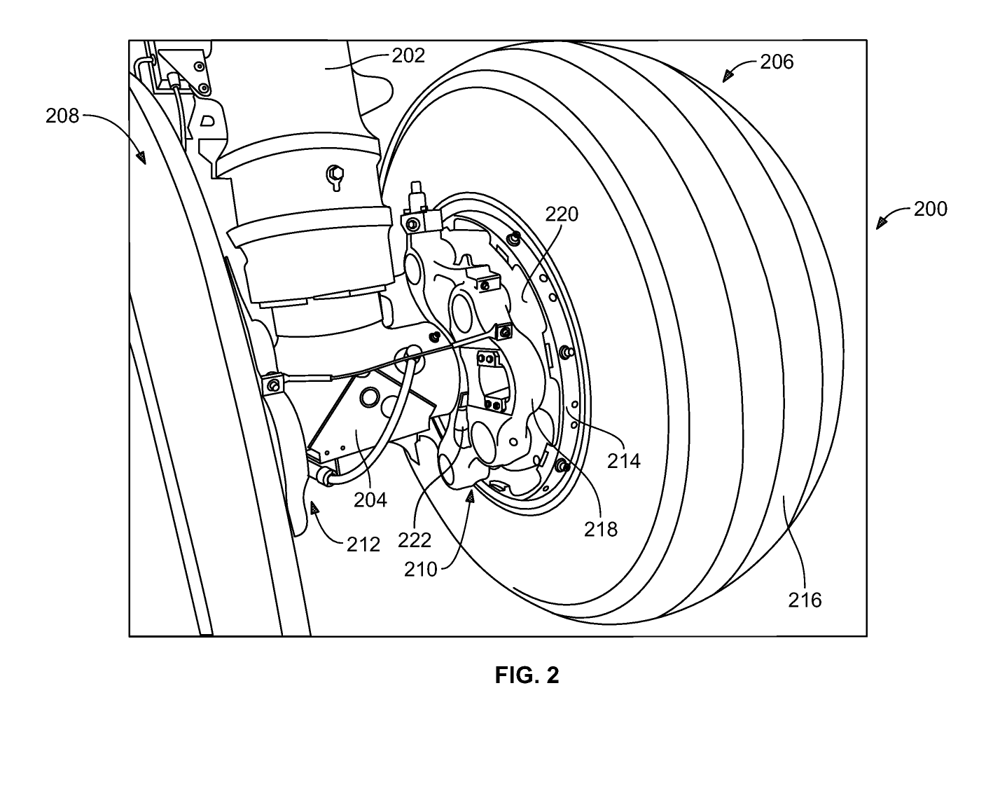

FIG. 2 illustrates an example landing gear system 200 including rolling stock, which may be used to implement the landing system 102 of the example aircraft 100 of FIG. 1. In the illustrated example, the landing gear system 200 includes a strut 202, an axle assembly 204, two wheel assemblies 206 and 208, and two brake assemblies 210 and 212. Each of the brake assemblies 210 and 212 is coupled to the axle assembly 204 and a respective one of the wheel assemblies 206 and 208. The example landing gear system 200 may include a plurality of actuators, sensors (e.g., temperature and/or pressure sensors) and/or other devices, which may be controlled by and/or communicate with one or more aircraft control systems of the example aircraft 100.

The wheel assemblies 206 and 208 of the example landing gear system 200 are substantially similar, and the brake assemblies 210 and 212 of the example landing gear system 200 are substantially similar. Thus, the following description of the brake assembly 210 and the wheel assembly 206 disposed on a right side of the strut 202 in the orientation of FIG. 2 is applicable to the brake assembly 212 and the wheel assembly 208 disposed on a left side of the strut 202 in the orientation of FIG. 2. Therefore, to avoid redundancy, the wheel assembly 208 and the brake assembly 212 on the left side of the strut 202 in FIG. 2 are not separately described.

In the illustrated example, the wheel assembly 206 includes a wheel 214 and a tire 216. The example brake assembly 210 includes a housing 218, brakes (e.g., one or more rotors and stators), pistons and/or other components. In the illustrated example, the brakes are received in a tubewell 220 of the wheel 214. When the brake assembly 210 is operated, the brakes convert kinetic energy of the wheel 214 into brake energy (e.g., heat energy). As a result, a temperature of the brake assembly 210 increases. In the illustrated example, a brake temperature sensor 222 (e.g., a thermocouple) is coupled to the landing gear system 200 to acquire information related to the temperature of the brake assembly 210 (“brake temperature information”). The example brake temperature sensor 222 of FIG. 2 is disposed on the housing 218 of the brake assembly 210. In other examples, the brake temperature sensor 222 may be coupled to other components of the brake assembly 210, the axle assembly 204, the strut 202, the wheel 214, and/or any other suitable component of the landing gear system 200. As described in greater detail below, the temperature of the brake assembly 210 may be used to estimate an increase in temperature of the wheel 214 as a result of a braking event.

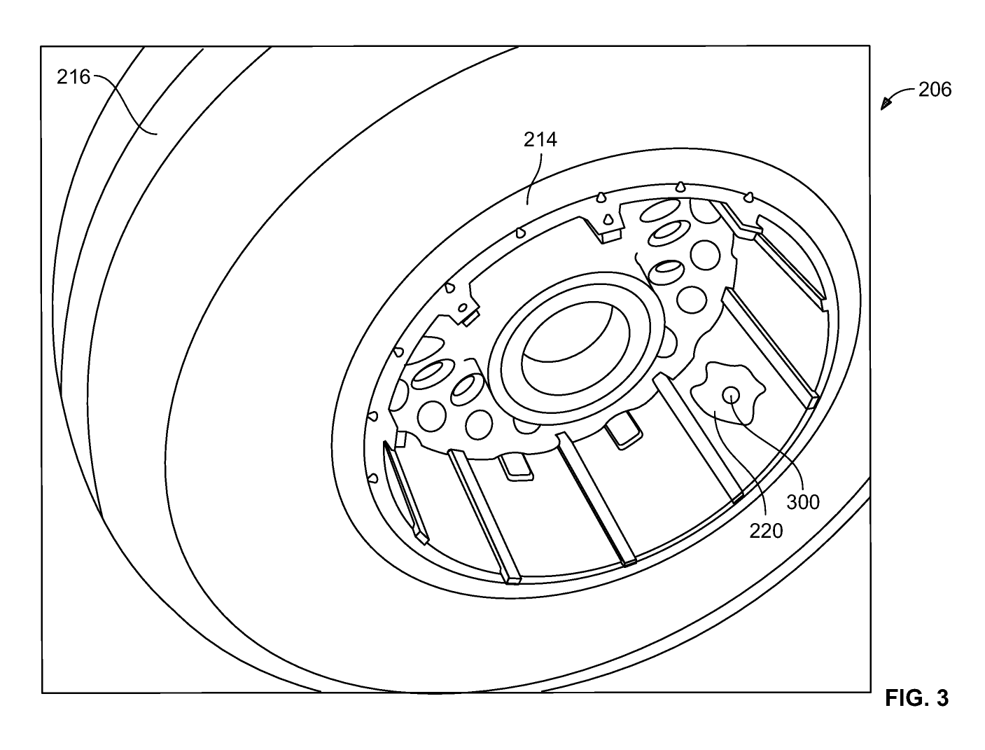

FIG. 3 is a view of a first side of the example wheel assembly 206 of FIG. 2. In the illustrated example, the wheel 214 includes an example fuse plug 300. The example fuse plug 300 is coupled to the wheel 214 via the tubewell 220. Although one fuse plug is shown in the illustrated example, the wheel 214 may include a plurality of fuse plugs, which may be spaced apart along the wheel 214 (e.g., three fuse plugs radially spaced apart by about 120 degrees).

The example fuse plug 300 of FIG. 3 is in communication with the interior space of the tire 216 between the wheel 214 and the tire 216. When a temperature of the fuse plug 300 is below a threshold temperature, the fuse plug 300 enables the tire 216 to remain inflated and/or pressurized. If the temperature of the fuse plug 300 reaches or exceeds the threshold temperature, a portion (e.g., a eutectic core or seal) of the fuse plug 300 melts to release air from in the tire 216.

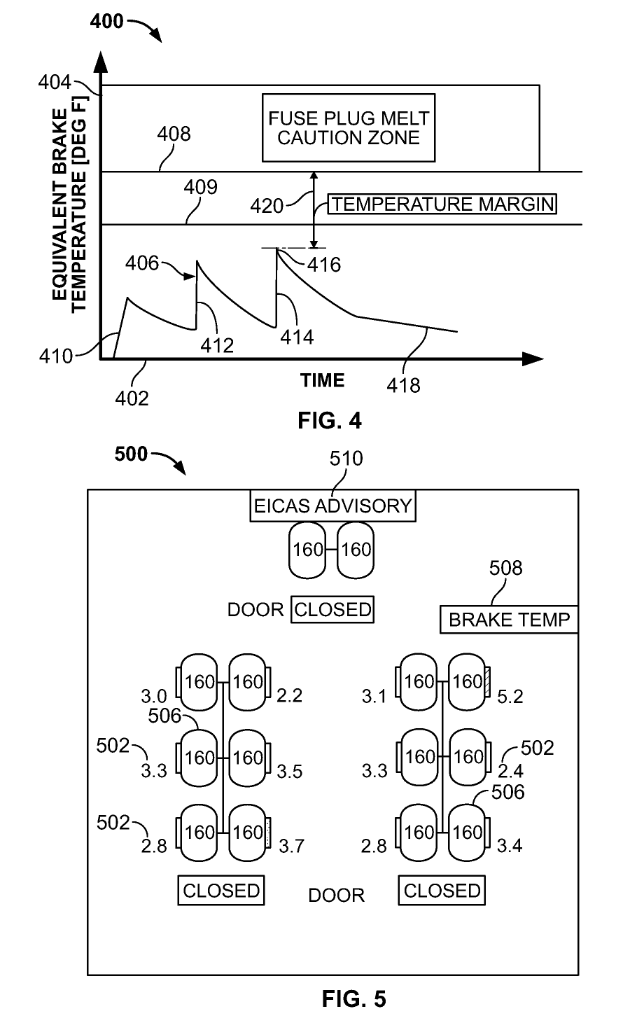

FIG. 4 is a graph 400 of a time-temperature history of brake temperature after numerous aircraft braking events. A horizontal axis 402 represents time and a vertical axis 404 represents equivalent brake temperature. A brake-temperature history 406 represents brake temperature as a function of time. A horizontal line 408 represents a threshold temperature at which a fuse plug may melt (e.g., plug melt caution zone) to release air from a tire and/or a brake warning light may be illuminated in a cockpit of the aircraft. Another horizontal line 409 represents a lower temperature threshold, below which the brake warning light may turn off after being illuminated. Brake temperature reaching or exceeding a temperature corresponding to the horizontal line 408 may result in an aircraft having to remain stationary for a period of time to allow the brakes to cool. Curve portions 410, 412, 414 of the brake-temperature history 406 depict rises in temperature of the brake after braking events Such rises in temperature may have a corresponding time delay (e.g., lag) due to thermal capacitance of the system. A peak 416 is the highest peak temperature of the brake-temperature history 406 corresponding to the curve portion 414 (e.g., the peak temperature curve) depicting a higher braking temperature due to residual heat. Another portion 418 of the brake-temperature history 406 depicts cooling of the brake after the peak temperature 416 has been reached. The cooling shown in the graph 400 illustrates a slow rate of cooling relative to the rise portion 414, which may result from the slower effects of dissipating heat to surrounding wheels, brakes and landing gear components, etc. An arrow 420 represents the margin between the peak temperature 416 of the brake-temperature history 406 and the horizontal line 408 (i.e., the threshold temperature at which a fuse plug may begin to melt).

FIG. 5 illustrates an example instrument panel 500 of an aircraft displaying brake temperature values. The panel 500 displays brake temperature as brake temperature monitoring system (“BTMS”) values 502 of respective tires 506. In this example, the BTMS values correspond to unitless parameters that are a ratio of a brake temperature to the temperature at which a fuse plug of the corresponding tire may release air from the tire. In some examples, a BTMS value may range from 0 to 9.9, however the fuse plug may melt at a range of approximately 5.0 to 7.0. The instrument panel 500 also includes a brake temperature warning 508 to indicate when a relatively high BTMS value may necessitate the aircraft to wait to allow the brake(s) to cool. In some examples, an Engine Indication and Crew Alerting System (“EICAS”) 510 may indicate a malfunction of one or more systems of the aircraft.

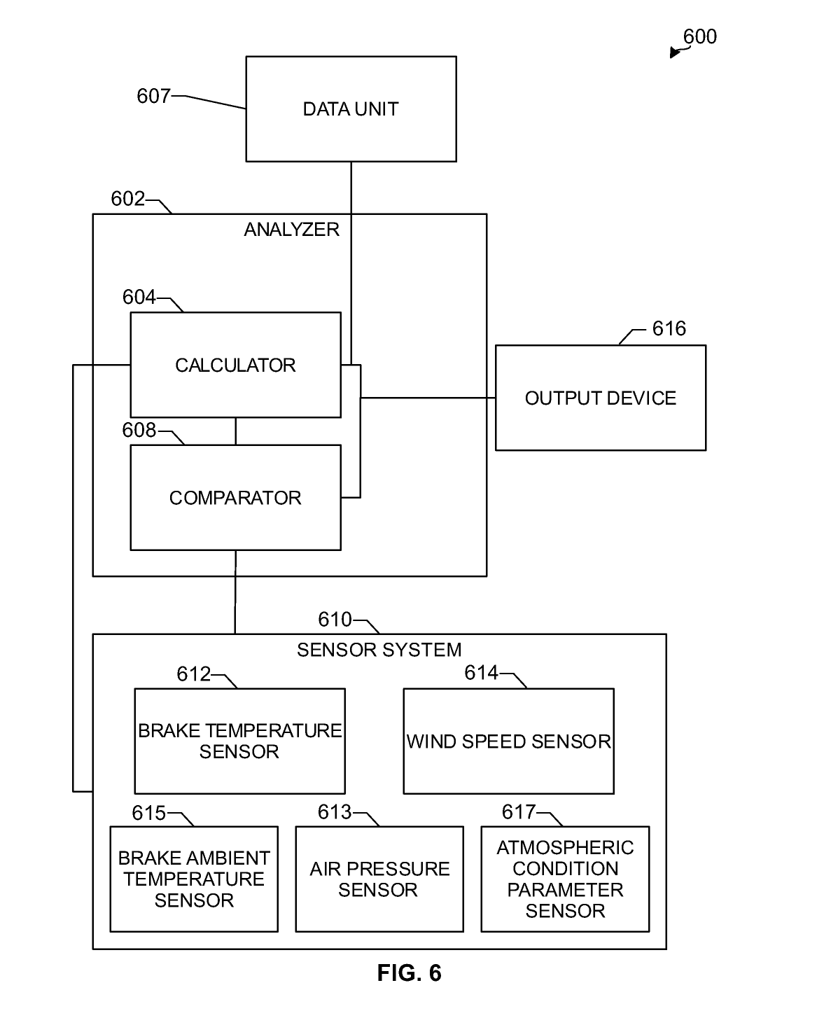

FIG. 6 is an example brake system apparatus 600 of an aircraft in accordance with the teachings of this disclosure. An analyzer 602 includes a calculator 604 and a comparator 608. In the illustrated example, the calculator 604 is communicatively coupled to a data unit 607 (e.g., a database, server, data storage unit, etc.). The data unit 607 of the illustrated example stores and/or receives brake energy data (e.g., the data may be received from a part of the aircraft or may be manually entered via an input screen or hand held device), reference brake energy data, autobrake setting data, reverse thrust data, a range of brake temperature data, autobrake deceleration level data, reverse thrust data, reference external conditions, initial brake temperature value(s) and/or BTMS data, etc. In some examples, the database stores and/or receives aircraft exit ground travel path information. In some examples, the data unit 707 stores and/or receives an atmospheric condition parameter(s) (e.g., external conditions) that may be, for example, humidity, wind conditions near the brake, radiative heat transfer, air pressure, etc. Additionally or alternatively, in some examples, the data unit 607 stores and/or receives aircraft exit ground travel path information

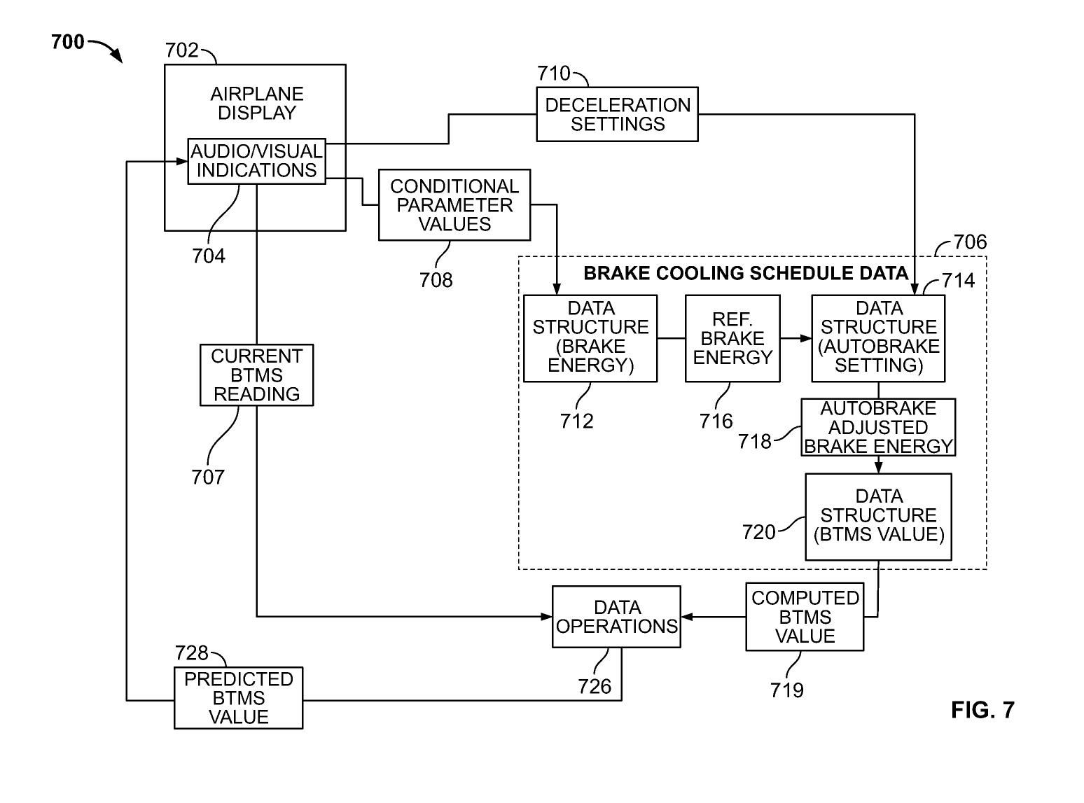

The calculator 604 and/or the comparator 608 may, for example, be communicatively coupled to a sensor system 610, which may include a brake temperature sensor 612 to measure BTMS values and/or brake temperatures (e.g., operating parameter values), an air pressure sensor 613, a wind speed sensor 614 (e.g., conditional parameter values) and/or a brake ambient temperature sensor 615, etc. In some examples, the atmospheric condition parameter sensor 617 measures atmospheric conditional parameters (e.g., atmospheric condition parameters, the conditional parameter values, etc.) including, but not limited to humidity, wind conditions near the brake, radiative heat transfer, gross weight of the aircraft, an elevation of a runway, computed groundspeed, necessary braking level for the groundspeed, ambient air temperature, pressure, altitude, velocity of the aircraft, and/or state of the brake(s) determined from numerous sensors. The state of the brake(s), for example, may be indicated by a wear pin of a brake, which ground operation staff may measure and input the measurement into the data unit 607, for example. In other examples, the state of the brake(s) may be automatically measured by the sensor system 610. The calculator 604 may, for example, receive data (e.g., the measured BTMS value and the conditional parameters from the sensor system 610 and/or the selected deceleration settings) to be used in conjunction with heat transfer equations and/or comparison data between the sensor system 610 and the data unit 607 to calculate predicted operating parameter values (e.g., BTMS values and/or dispatch turn time) by performing a data operation such as, for example, an addition operation in which the measured operating parameter value and a computed operating parameter value (e.g., an additive value calculated by the calculator 604) are summed together. In some examples, the conditional parameter values, deceleration settings, calculated brake temperatures and/or operating parameter values corresponding to pre-determined exit routes may be utilized by the calculator 604 to determine computed operating parameter values corresponding to the pre-determined exit routes. In some examples, database values such as, for example, data structures 712, 714, 716, 718, 720 and/or, more generally, brake cooling schedule data 706 described below in connection with FIG. 7, which are implemented or stored in the data unit 607, may include reference values to be compared to, via the calculator 604 and/or the comparator 608, the conditional parameter value measurements and/or the operating parameter measurements to determine the computed operating parameter values (e.g., the computed BTMS value BTMS additive value and/or predicted dispatch turn time). Additionally or alternatively, the autobrake deceleration levels and/or the reverse thrust settings (e.g., the deceleration settings 710) may be received by the calculator 604 from the data unit 607 (e.g., provided from cockpit settings, currently selected settings, records, tables, user inputs, etc. within the data unit 607) to determine the predicted operating parameter value. In the illustrated example, an autobrake system is used to establish a minimum level of braking applied (e.g., minimum braking level threshold) for the aircraft during landing.

In some examples, the empirical database (e.g., empirical reference condition data) may include multivariable charts relating to brake cooling times based on brake temperature data, ambient temperature data, brake material depletion, brake status, initial brake temperature, brake material depleted during a previous brake deployment(s), predicted brake material depletion, predicted brake temperature rise, brake structure and material, landing gear structure and material, deceleration levels, and/or exit points or travel pathways on the ground. Brake material depletion is a cumulative process, where the brake friction surfaces are worn down by use. The predicted brake material depletion amount may be calibrated to an actual brake material amount and/or reset based on inspection by a brake technician. Additionally or alternatively, the calculator 604 of the analyzer 602 may use heat transfer equations/relationships (e.g., multivariable analysis) to determine the predicted dispatch turn time based on any of the factors mentioned above.

The predicted operating parameter value may be displayed via an output device 616 in an airplane display 702, a tablet (e.g., iPad™), and/or audio/visual indications 704 described below in connection with FIG. 7, for example. In some examples, the output device 616 may also trigger a message when the computed BTMS value, the predicted BTMS value and/or the predicted dispatch turn time exceed a threshold based on a comparison with a threshold value at the comparator 608, for example.

While an example manner of implementing the examples described herein is illustrated in FIG. 6, one or more of the elements, processes and/or devices illustrated in FIG. 6 may be combined, divided, re-arranged, omitted, eliminated and/or implemented in any other way. Further, the example analyzer 602, the example data unit 607, the example sensor system 610, the example output device 616 and/or, more generally, the example brake system apparatus 600 of FIG. 6 may be implemented by hardware, software, firmware and/or any combination of hardware, software and/or firmware. Thus, for example, any of the example analyzer 602, the example data unit 607, the example sensor system 610, the example output device 616 and/or, more generally, the example brake system apparatus 600 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example analyzer 602, the example data unit 607, the example sensor system 610, and/or the example output device 616 is/are hereby expressly defined to include a tangible computer readable storage device or storage disk such as a memory, a digital versatile disc (DVD), a compact disc (CD), a Blu-ray disc, etc. storing the software and/or firmware. Further still, the example brake system apparatus 600 may include one or more elements, processes and/or devices in addition to, or instead of, those illustrated in FIG. 6, and/or may include more than one of any or all of the illustrated elements, processes and devices.

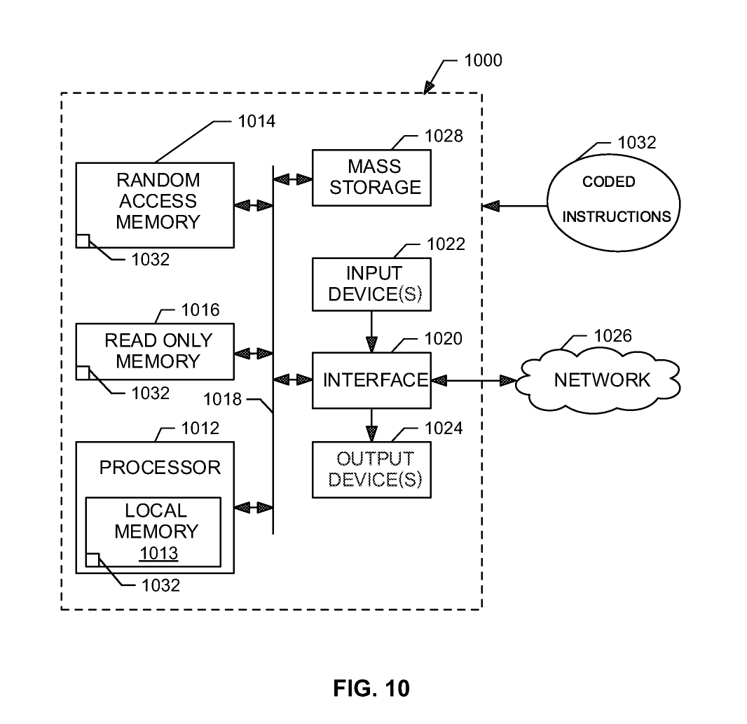

FIG. 7 is a schematic representation 700 that may be used to implement the brake system 600 of FIG. 6. The brake temperature system 700 may be used for the process of landing the aircraft, for example. The airplane display 702 of the illustrated example has the audio/visual indications 704 and is communicatively coupled to the brake cooling schedule data 706. The audio/visual indications 704 may display information such as shown in the panel 500 described above in connection with FIG. 5. The displayed information may include a current BTMS reading value 707, which may be measured by the brake temperature sensor 612 described above in connection with FIG. 6. Additionally, the audio/visual indications 704 may display information such as described below in connection with the example display 1000 of FIG. 10. In some examples, the airplane display 702 and/or the audiovisual indications 704 provide conditional parameter values 708 based on sensor measurements to the brake cooling schedule data 706. As mentioned above, the conditional parameter values 708 may include gross weight of the aircraft, an elevation of a runway, computed groundspeed, ambient brake temperature, necessary braking level for the groundspeed, ambient air temperature, pressure, altitude, aircraft velocity, and/or state of the brake(s) determined from numerous sensors in the sensor system 610, for example. In the illustrated example, the airplane display 702 and/or the audio/visual indications 704 provide deceleration settings 710 to the brake cooling schedule data 706. The deceleration settings 710 may include thrust reverser detent settings and/or autobrake deceleration levels (e.g., equivalent autobrake settings to the thrust reverser detent settings).

In the illustrated example, the conditional parameter values 708 are provided to a data structure (e.g., a table) 712 that calculates, compares and/or references brake energy data and/or data related to brake energy data based on the conditional parameter values 708. The data structure 712 may, for example, use heat transfer relationships, and/or any appropriate calculation(s) to determine the corresponding brake energy. Likewise, in this example, the deceleration settings 710 are provided to a data structure (e.g., a table) 714 that includes autobrake setting data and/or data related to autobrake deceleration levels to determine necessary deceleration levels of the brakes based on, for example, a runway length, aircraft speed, gross weight, etc. In the illustrated example, the brake energy value from reference tables is determined via a reference data structure (e.g., a table) 716. The reference data structure 716 of the illustrated example may be used to provide a reference data point for brake energy based on the conditional parameter values 708 (e.g., a reference table look up). In some examples, the data structure 714 is used to determine which autobrake deceleration level to recommend or use based on the conditional parameter values 708 and/or the deceleration settings 710.

In some examples, the determined brake energy values from the data structure 712 and/or the reference data structure 716 are used in conjunction with the autobrake develeration level(s) of the data structure 714 and/or the reference data structure 716 to determine (e.g., calculate) an autobrake (“A/B”) adjusted brake energy 718. In some examples where multiple adjusted brake energies are calculated due to, for example, numerous exit points and/or deceleration settings, the most conservative brake energy (e.g., the highest determined brake energy) may be selected as the AB adjusted brake energy 718. The adjusted brake energy 718 of the illustrated example is then used to determine a computed BTMS value 719 (e.g., additive BTMS value or additional BTMS increments due to the predicted landing of the aircraft) via a data structure (e.g., a table) 720, which has reference BTMS values. In the illustrated example, the computed BTMS value 719 is combined with a current BTMS measurement (e.g., reading) 707 via a data operation 726, which may be an addition operation, for example. In other examples, the computed BTMS value 719 and the BTMS measurement 707 may be weighted together or any other appropriate mathematical operation(s) may be performed in the data operation 726 to account for the computed BTMS value 719 and/or the BTMS measurement 707. Based on the data operation 726, a predicted BTMS value 728 is provided to the airplane display 702 and/or the audio visual indications 704. The brake system 700 provides predicted BTMS values and/or brake temperatures based on the conditional parameter values 708, the deceleration settings 710, and/or current BTMS measurements 707. In some examples, the brake system 700 may rely on potential ground exit points, runway length, etc. to determine a predicted BTMS value. While BTMS values are described in this example, the brake system 700 may be used to predict any relevant operating parameter of the aircraft. The brake system 700 may additionally or alternatively be used to predict dispatch turn time for the aircraft.

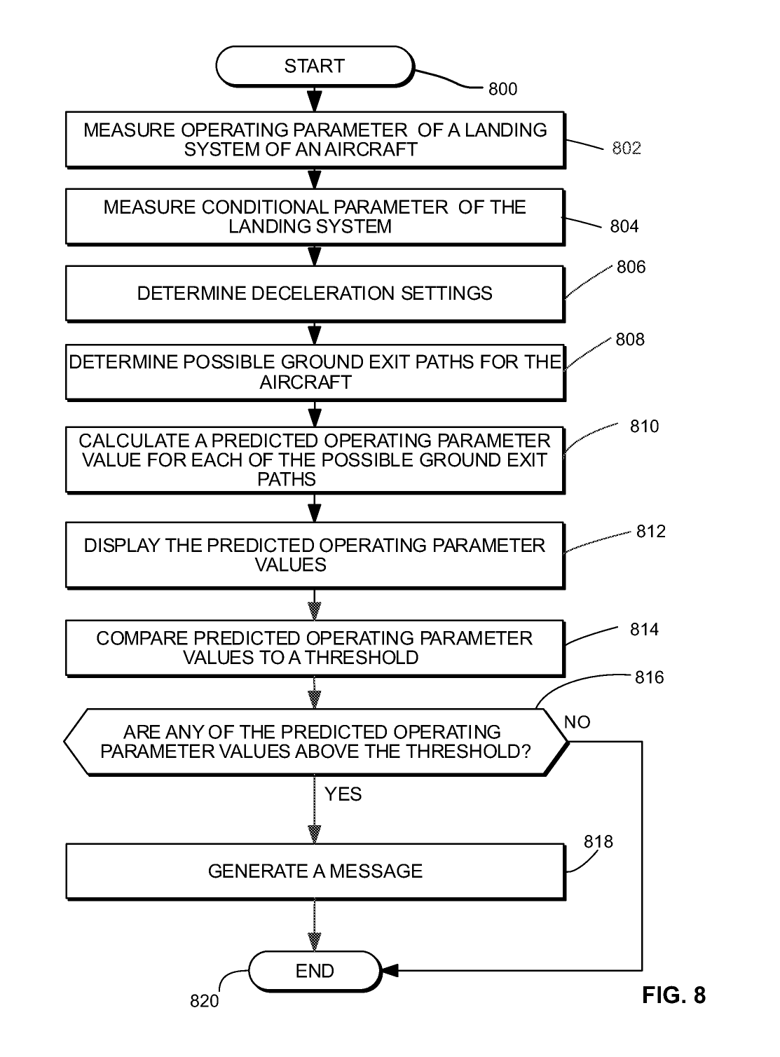

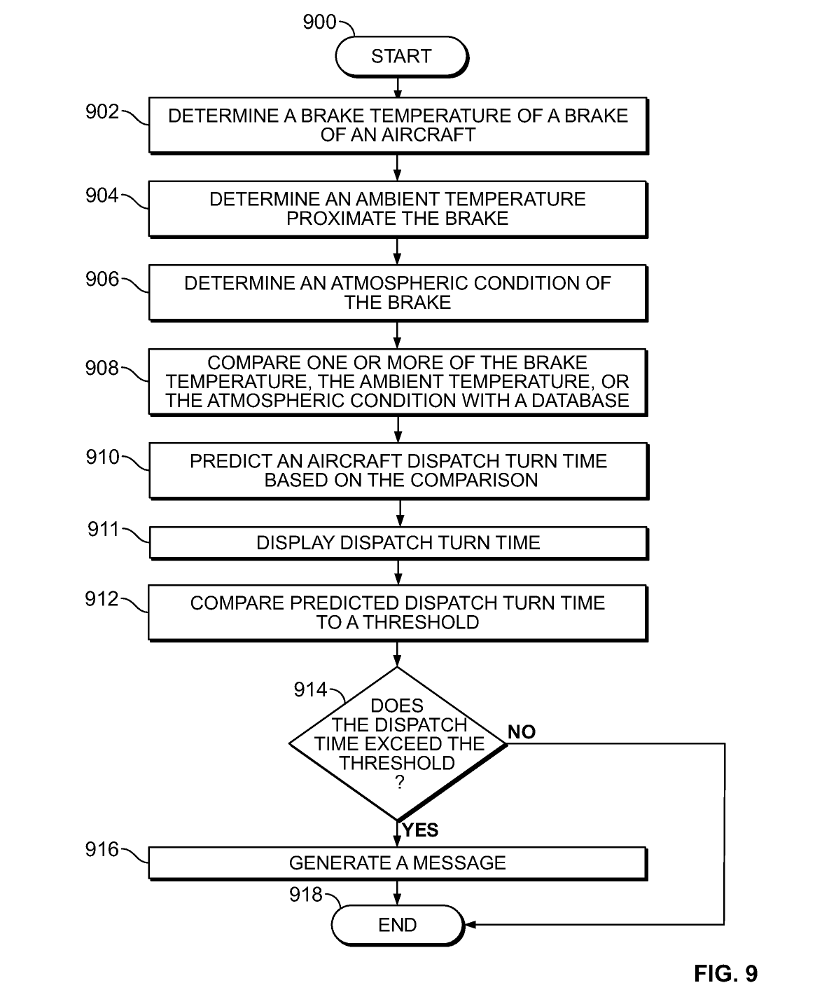

Flowcharts representative of example methods that may be used to implement the brake system apparatus 600 are shown in FIGS. 8 and 9. In these examples, the method may be implemented using machine readable instructions that comprise a program for execution by a processor such as the processor 1012 shown in the example processor platform 1000 discussed below in connection with FIG. 10. The program may be embodied in software stored on a tangible computer readable storage medium such as a CD-ROM, a floppy disk, a hard drive, a digital versatile disc (DVD), a Blu-ray disc, or a memory associated with the processor 1012, but the entire program and/or parts thereof could alternatively be executed by a device other than the processor 1012 and/or embodied in firmware or dedicated hardware. Further, although example programs are described with reference to the flowcharts illustrated in FIGS. 8 and 9, many other methods of implementing the brake system apparatus 600 may alternatively be used. For example, the order of execution of the blocks may be changed, and/or some of the blocks described may be changed, eliminated, or combined.

The example method of FIG. 8 is described below in connection with the brake system apparatus 600 of FIG. 6 and the schematic representation 700 of FIG. 7. The example method of FIG. 8 begins at block 800 where an aircraft is about to land (block 800). An operating parameter of a landing system of the aircraft such as, for example, a BTMS value (e.g., the BTMS measurement 707) and/or a brake temperature/parameter is determined (e.g., measured) (block 802) at a brake temperature sensor such as the brake temperature sensor 612 described above in connection with FIG. 6. One or more conditional parameters such as, for example, the conditional parameter values 708 (e.g., gross weight of the aircraft, runway elevation, computed ground speed, ambient air temperature, pressure, altitude, velocity of the aircraft, and/or state of the brake, etc.) are determined (e.g., measured) (block 804) at the sensors 613, 614, 615, 617 described above in connection with FIG. 6, for example. In some examples, possible deceleration settings (e.g., thrust reverser detent settings, autobrake deceleration level, selected deceleration levels, etc.) are determined (block 806). Possible ground exit paths for the aircraft are then determined (block 808) at the data unit 607, for example. Next, a predicted operating parameter value is determined for each of the possible ground exit paths (block 810) at the calculator 604 of the analyzer 602, for example. The predicted operating parameter value (e.g., the predicted value 728) determined for each of the possible ground travel paths is determined by the brake cooling schedule data 706 in combination with the BTMS measurement 707 via a summing operation, for example. An output device then displays each of the predicted operating parameter values (block 812) at the output device 616, for example. Each of the predicted operating parameter values is compared to a threshold (block 814) at the comparator 608, for example. If any of the predicted operating parameter values exceed the threshold (block 816), a message is generated (block 818) at the output device 616, for example, and the process ends (block 820). Alternatively, if any of the predicted operating parameter values does not exceed the threshold (block 816), the process ends (block 820).

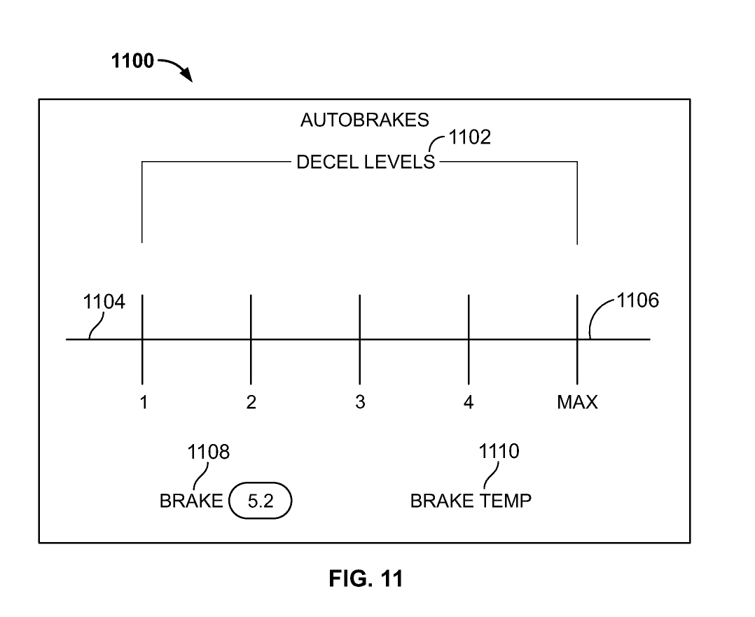

The example method of FIG. 9 is described below in connection with the brake system apparatus 600 of FIG. 6. The example method of FIG. 9 begins at block 900 where an aircraft is about to land (block 900). A BTMS value and/or a brake temperature/parameter (e.g., the BTMS reading 707) is determined (e.g., measured) (block 902) at a brake temperature sensor such as, for example, the brake temperature sensor 612 described above in connection with FIG. 6. An ambient temperature, which may be proximate the brake, is determined (e.g., measured) at a brake ambient temperature 615 of the sensor system 610, for example (block 904). One or more atmospheric condition parameters are determined (e.g., measured) (block 906) at the sensor 617, for example. In the illustrated example, one or more of the brake temperature, the measured ambient brake temperature (block 904) and/or the atmospheric condition parameter is compared to and/or referenced to the empirical database (e.g., empirical data points) stored in the data unit 607 (block 908) to predict a dispatch turn time for each of the possible ground exit travel paths at the calculator 604 of the analyzer 602, for example (block 910). In some examples, the predicted dispatch turn time is determined for a specifically selected ground travel path and/or deceleration setting (e.g., the deceleration settings 710). In some examples, the analyzer 602 utilizes heat transfer principles (e.g., equations or relations) such as, for example, convection equations, conduction equations, radiation equations and/or calculations based on the material and/or structure of the landing system or the brakes. In some examples, the prediction may also be based on brake depletion, brake conditions, etc. Additionally or alternatively, the dispatch turn time may be predicted using regression techniques (e.g., regression techniques using data from a database (e.g., the reference brake data 716 of FIG. 7, linear regression techniques, etc.). An output is then displayed corresponding to each of the predicted dispatch turn times (block 911) at the aircraft displays/indications 704 and/or the output displays 1100, 1200 and 1300 described below in connection with FIGS. 11-13, respectively. Each of the predicted dispatch turn times is compared to a threshold (block 912) at the comparator 608, for example. If any of the predicted dispatch turn times exceeds the threshold and/or necessitates a waiting time (e.g., any of the predicted turn times are greater than zero) (block 914), a message is generated (block 916) at the aircraft displays/indications 704, for example, and the process ends (block 918). In some examples, a message is generated (block 916) when the aircraft has not waited long enough (e.g., a message is generated when a waiting threshold is not met). Alternatively, if any of the predicted operating parameter values does not exceed the threshold (block 914), the process ends (block 918).

As mentioned above, the example processes of FIGS. 8 and 9 may be implemented using coded instructions (e.g., computer and/or machine readable instructions) stored on a tangible computer readable storage medium such as a hard disk drive, a flash memory, a read-only memory (ROM), a compact disc (CD), a digital versatile disc (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 8 and 9 may be implemented using coded instructions (e.g., computer and/or machine readable instructions) stored on a non-transitory computer and/or machine readable medium such as a hard disk drive, a flash memory, a read-only memory, a compact disc, a digital versatile disc, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 10 is a block diagram of an example processor platform capable of executing the instructions of FIGS. 8 and 9 to implement the brake system apparatus 600 of FIG. 6. The processor platform 1000 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1020 of the illustrated example, thus, typically includes a graphics driver card.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disc drives, Blu-ray disc drives, a plurality of storage devices cooperatively assembled into a Redundant Array of Independent Disks (RAID) system, and digital versatile disc (DVD) drives.

Coded instructions 1032 to implement the methods described herein may be stored in the mass storage device 1028, in the volatile memory 1014, in the non-volatile memory 1016, and/or on a removable tangible computer readable storage medium such as a CD or DVD.

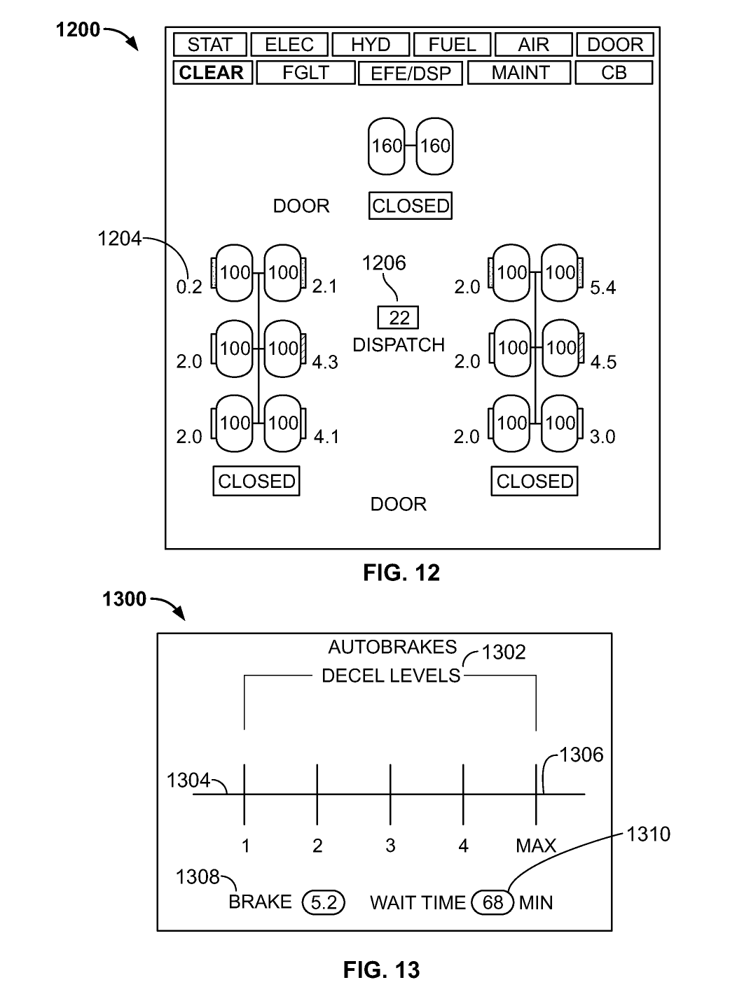

FIG. 11 illustrates an example output display 1100 for use with the examples disclosed herein. The example output of the illustrated example may be displayed on a screen and/or a tablet (e.g., iPad™) in a cockpit of an aircraft and/or used in conjunction with the example instrument panel 500 described in connection with FIG. 5 and/or the output display 1200 described below in connection with FIG. 12. The example display 1100 of the illustrated example has a deceleration indicator 1102 to illustrate the autobrake deceleration levels (e.g., minimum level of braking automatically set to engage during landing) that may be used to decelerate the aircraft during landing and/or braking. In the illustrated example, a first end 1104 of the deceleration indicator 1102 is the minimum autobrake deceleration level while a second end 1106 of the deceleration indicator 1102 corresponds to the maximum autobrake deceleration level. In the illustrated example, a peak predicted BTMS value 1108 corresponding to the selected autobrake deceleration level is displayed. In the illustrated example, a break temperature warning 1110, which indicates if the brake heat temperature exceeds a brake temperature threshold, is also displayed.

FIG. 12 illustrates an example output display 1200 for use with the examples disclosed herein. The example output of the illustrated example may be displayed on a screen and/or a tablet (e.g., iPad™) in a cockpit of an aircraft and/or used, alternatively or additionally, with the example instrument panel 500 described in connection with FIG. 5 and/or the output display 1100 described above in connection with FIG. 11. Similar to the instrument panel 500, the example display 1200 of the illustrated example includes BTMS values 1204. In the illustrated example, the output display 1200 also displays an estimated dispatch turn time 1206, which may be displayed in minutes or seconds. In some examples, the estimated dispatch turn time 1206 may be based on currently selected decelerations settings (e.g., autobrake and/or thrust reverser settings, etc.). In other examples, numerous estimated dispatch times may be displayed based on possible ground travel exit paths.

FIG. 13 illustrates another example output display 1300 for use with the examples disclosed herein. The example display 1300 of the illustrated example has a deceleration indicator 1302 to illustrate the autobrake deceleration levels (e.g., minimum level of braking automatically set to engage during landing) that may be used to decelerate the aircraft during landing and/or braking. In the illustrated example, a first end 1304 of the deceleration indicator 1302 is the minimum autobrake deceleration level while a second end 1306 of the deceleration indicator 1302 corresponds to the maximum autobrake deceleration level. In the illustrated example, a peak predicted BTMS value 1308 corresponding to the selected autobrake level is displayed. In the illustrated example, the display 1300 shows an estimated dispatch turn time (e.g., a wait time) 1310, which indicates the estimated dispatch turn time. In some examples, this estimated dispatch turn time is additionally based on deceleration settings (e.g., selected autobrake deceleration levels and/or thrust reverser detent settings). The example output display 1300, in some examples, is used in combination with the output displays, 1100, 1200 a tablet (e.g., iPad™) and/or the instrument panel 500.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent. While aircraft are described, the example apparatus may be applied to vehicles, aerodynamic structures, etc.

What is claimed is:

1. A method comprising:
measuring a value of an operating parameter of a landing system of an aircraft;
determining a ground travel path; and
calculating, using a processor, a predicted value of the operating parameter corresponding to the ground travel path, wherein the predicted value is based on the value of the operating parameter and the ground travel path.

2. The method as defined in claim 1, wherein calculating the predicted value is based on a comparison of the measured value to an empirical database.

3. The method as defined in claim 1, wherein the operating parameter is brake temperature or dispatch turn time.

4. The method as defined in claim 1, wherein calculating the predicted value of the operating parameter is further based on an external condition, the external condition including one or more of ambient air temperature, air pressure, or wind speed.

5. The method as defined in claim 1, wherein calculating the predicted value of the operating parameter is based on an internal condition, the internal condition including one or more of brake temperature, thrust reverser settings, or autobrake deceleration level.

6. The method as defined in claim 1, wherein calculating the predicted value of the operating parameter is based on heat transfer equations using one or more of a brake structure and material, landing gear structure and material, brake temperature, predicted brake material depletion, brake material depleted during a previous brake deployment or an external condition, the external condition including one or more of ambient air temperature, air pressure, or wind speed.

7. An apparatus comprising:
a sensor mounted to a landing system of an aircraft to measure an operating parameter of the landing system; and
a calculator to calculate a predicted value of the operating parameter based on the operating parameter and one or more of a measured external condition or a potential ground travel path.

8. The apparatus as defined in claim 7, wherein the measured external condition is measured proximate a brake of the landing system.

9. The apparatus as defined in claim 7, wherein the calculator calculates the predicted value further based on one or more of a ground travel path or a deceleration setting.

10. The apparatus as defined in claim 7, wherein the calculator calculates the predicted value further based on a comparison with empirical data.

11. The apparatus as defined in claim 10, wherein the empirical data comprises one or more of a range of brake temperature data, ambient temperature data, or empirical reference condition data.

12. The apparatus as defined in claim 7, wherein the calculator is to use heat transfer equations based on one or more of a brake structure and material, a landing gear structure and material, brake temperature, ambient temperature, or an external condition.

13. The apparatus as defined in claim 7, wherein the operating parameter comprises a brake temperature or dispatch turn time.

14. The apparatus as defined in claim 7, further comprising one or more additional sensors to measure a value of one or more of wind speed, air pressure, or velocity of the aircraft, wherein the value is to be used to determine the predicted value of the operating parameter.

15. The apparatus as defined in claim 7, wherein when the predicted value of the operating parameter exceeds a threshold, a message is generated.

16. A method comprising:
measuring an operating parameter of a landing system of an aircraft;
measuring a conditional parameter of the landing system; and
comparing, using a processor, one or more of the operating parameter or the conditional parameter to empirical data to predict a dispatch turn time or brake temperature value of the aircraft.

17. The method as defined in claim 16, wherein the empirical data comprises brake cooling times for different conditions.

18. The method as defined in claim 16, wherein the empirical data is from a database comprising one or more of a range of brake temperature data, ambient temperature data, brake condition, or empirical reference condition data.

19. The method as defined in claim 16, wherein the operating parameter comprises brake temperature and the conditional parameter comprises brake ambient temperature.

20. The method as defined in claim 16, wherein the prediction of dispatch turn time or brake temperature value is further based on one or more of predicted brake material depletion, or brake material depleted during a previous brake deployment.
